(19) United States
(12) Patent Application Publication
(10) Pub. No.: US 2015/0091396 A1
(43) Pub. Date: Apr. 2, 2015

(54) End Shield With Extrusions For Mounting The End Shield To A Stator Stack

(71) Applicant: Nidec Motor Corporation, St. Louis, MO (US)

(72) Inventors: Gary W. Borcherding, St. Louis, MO (US); Philip S. Johnson, St. Louis, MO (US)

(73) Assignee: Nidec Motor Corporation, St. Louis, MO (US)

(21) Appl. No.: 14/041,616

(22) Filed: Sep. 30, 2013

(51) Int. Cl. H02K 5/22; H02K 15/02; H02K 5/02

(52) U.S. Cl. CPC H02K 5/22; H02K 5/02; H02K 15/02
USPC 310/43; 310/91; 29/596

(57) ABSTRACT

A mounting feature plate rigidly mounts a mounting feature to a stator of an electrical motor in proximity to an end shield to help maintain a predetermined air gap between a rotor and a stator in the electrical motor. The mounting feature plate includes a planar member, an offset member extending from the planar member that has a mounting feature configured to mount an electrical motor within an appliance, and a pair of flanges extending from the planar member. Each of the flanges has an opening with a cylindrical extrusion aligned with and extending from the opening. The extrusions are configured to be received within a mounting hole within a stator to enable a bolt to pass through the opening and the extrusion and be received within the mounting hole in the stator.

### TECHNICAL FIELD

This disclosure relates generally to electrical motors, and more particularly, to end shields mounted to stators in electrical motors.

### BACKGROUND

Electrical motors are comprised of a rotor that can be axially received within an opening in a stator. The stator typically has teeth that extend into the opening to form a diameter in which the rotor is received. Electrical conductors are mounted about the teeth to enable an electrical current in the conductors to generate a rotating magnetic field. The rotor is configured for rotation in response to the magnetic field generated by the stator. This rotor is fixedly mounted about a shaft that rotates with the rotor. This shaft is held by journal bearings positioned within end shields mounted at each end of the housing in which the stator and rotor are positioned. The journal bearings in the end shields hold the rotor in position and mounting members, typically bolts or other threaded members, pass through openings in one of the endplates and mounting holes within an outer portion of the stator to be received in a threaded opening in the other end shield to hold the stator in position. When the end shields are mounted about the rotor shaft and the bolts are received in the stator mounting holes and threaded openings in the end shield, the air gap established between the inside of the stator and the outside of the rotor is important for efficient operation of the motor.

Some electrical motors are used in common appliances. For example, clothes dryers and washers use an electrical motor to rotate a drum in which wet clothes are placed for drying or washing, respectively. To reduce the weight of the appliance, some parts of the motor are made of plastic materials or the like. For example, some electrical motors are assembled with end shields that are formed with plastic materials. One advantage of using end shields fabricated with plastic materials is that the end shields can be formed with other features integrated in the component. In some electric motors having plastic end shields, the end shield is formed using injection molding techniques to incorporate a motor mounting feature in the end shield.

The motor mounting feature incorporated in the end shield is typically resilient enough to withstand the vibrations that occur within the appliance during its operational life. Issues have arisen, however, during the shipping of appliances from the place of manufacture to the location where the appliance is put into its operational life. Drops and/or bumps may be severe enough to stress the motor mounting feature to the point where the feature cracks and, in some cases, disconnects from the appliance structure to which the motor is mounted. Dislodging of the motor can result in movement of the end shield and the rotor mounted to the bearing within the end shield that may be sufficient to alter the air gap between the stator and the rotor. Thus, the motor does not operate at its most efficient levels. Therefore, constructing an electrical motor with a motor mounting feature that is more resistant to transportation stresses without appreciably adding weight to the motor is desirable.

### SUMMARY

A mounting feature plate that can be mounted to a stator in a way that maintains the air gap between the rotor and the stator while providing a more resilient mounting feature has been developed. The mounting feature plate includes a planar member, an offset member extending from the planar member, a terminating portion of the offset member being configured to engage a portion of a frame in an appliance for mounting an electrical motor within an appliance, and a pair of flanges extending from the planar member in a direction that is generally orthogonal to the planar member, each of the flanges in the pair of flanges having an opening with a cylindrical extrusion aligned with and extending from the opening, the extrusion being configured to be received within a mounting hole within a stator and the opening being configured to enable a bolt to pass through the opening and the extrusion to be received within the mounting hole in the stator.

An electrical motor includes a mounting feature plate that can be mounted to a stator in a way that maintains the air gap between the rotor and the stator while providing a more resilient mounting feature stator. The motor includes an output shaft, a rotor mounted about the output shaft, an end shield with an opening through which the output shaft extends, a stator secured to the end shield, and a mounting feature plate interposed between the end shield and the stator. The mounting feature plate includes a planar member, an offset member extending from the planar member, a terminating portion of the offset member being configured to engage a portion of a frame in an appliance for mounting the electrical motor within an appliance, and a pair of flanges extending from the planar member in a direction that is generally orthogonal to the planar member, each of the flanges in the pair of flanges being interposed between a surface of the end shield and a surface of the stator, each flange having an opening with a cylindrical extrusion aligned with and extending from the opening, the extrusion being configured to be received within a mounting hole within the stator and the opening being configured to enable a bolt to pass through the opening and the extrusion to be received within the mounting hole in the stator.

A method for assembling the electrical motor with the mounting feature plate includes aligning openings in flanges of a hard metal mounting feature plate with threaded mounting holes in a stator to enable extrusions extending from the hard metal mounting feature plate to be received by the stator mounting holes, aligning mounting holes in an end shield with the openings in the flanges of the mounting feature plate, inserting a bolt into each of the mounting holes in the end shield and through the aligned opening in the mounting feature plate to position an end of each bolt in one of the threaded holes in the stator, and rotating each bolt to advance each bolt into one of the threaded holes in the stator to secure the end shield and the mounting feature plate to the stator.

### BRIEF DESCRIPTION OF THE DRAWINGS

FIG. 1 is a perspective view of an electrical motor formed with a plastic end shield, a hard metal mounting feature plate, and a stator.

FIG. 2 is a perspective view of the hard metal mounting plate used to form the electrical motor of FIG. 1.

FIG. 3 is a cross-sectional view of a bolt passing through a mounting hole in the end shield, an opening in a flange of the mounting feature plate, and a threaded hole in the stator of FIG. 1.

FIG. 4 is a flow diagram of a process for assembling the electrical motor of FIG. 1.

FIG. 5 is a perspective view of a prior art plastic end shield that has an integrated mounting feature that can break away from the end shield during appliance transit.

### DETAILED DESCRIPTION

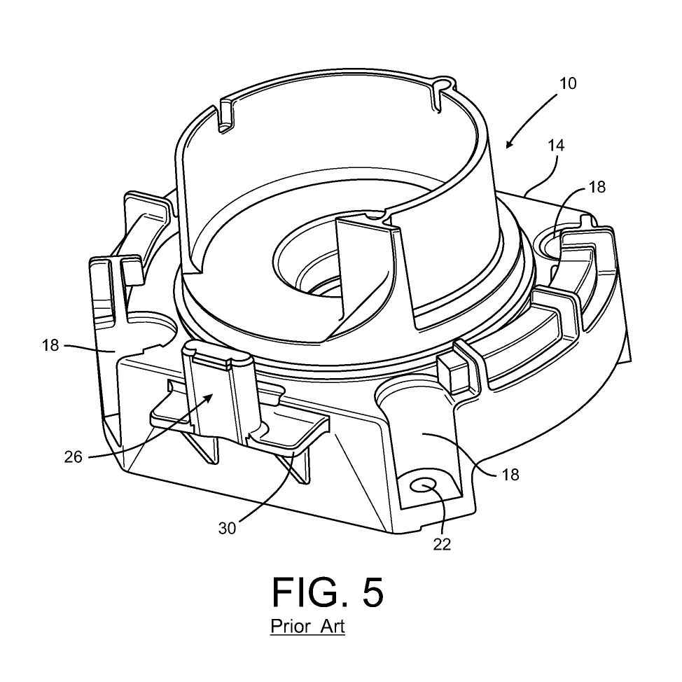

FIG. 5 shows a prior art end shield 10 that mounts to a stator of an electrical motor. The end shield 10 includes a body 14 having mounting slots 18. At a base of each slot 18 is an opening 22 that enables a mounting bolt to pass through the body 14 of end shield 18 so the bolt can pass through a mounting hole in a stator so the bolt end reaches a threaded hole in the end shield at the other end to secure the end shields to the stator. The body 14 of the end shield 10 includes a mounting feature 26 that is connected to the body 14 by an offset member 30. The offset member 30 and the mounting feature 26 are integrally formed with the body 14 of the end shield 10 as an injection molded component. As noted previously, the injection molded mounting feature 26 is sufficiently resilient that it can withstand vibrations that occur within the appliance in which the motor is installed. The thermoplastic material of which the offset member 30 and mounting feature 26 are made can crack and/or break during transit of the appliance. In these situations, the motor is not adequately secured within the appliance and the malfunction of the appliance may eventually occur.

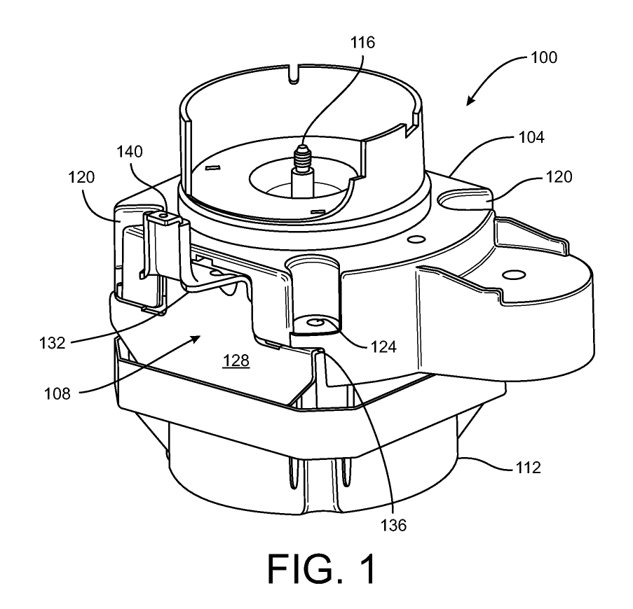

An improved electrical motor construction is shown in FIG. 1. A portion of an electrical motor 100 is shown in the figure. The illustrated portion includes an end shield 104, a mounting feature plate 108, and a stator 112. An output shaft 116 of a rotor (not shown) extends through an opening in the end shield 104. This shaft is supported by a bearing (not shown) in the end shield opening. The end shield includes mounting slots 120, each of which has an opening 124. The mounting feature plate 108 includes a planar member 128, an offset member 132, and a pair of flanges 136, one of which is partially visible in FIG. 1. The offset member 132 terminates into a mounting feature 140, which is used to mount the electrical motor 100 within an appliance. The mounting feature plate 108 is discrete and separate from the end shield 104 and the stator 112.

The end shield 104 is fabricated from thermoplastic materials using an injection molding machine or the like. The end shield 104 differs from the end shield 10 (FIG. 5) in that it has no mounting feature integrally formed in it. Instead, the mounting feature 140 is formed in the mounting feature plate 108. Mounting feature plate 108 is preferably a part stamped from a relatively hard metal, such as steel, although other metals can be used. The use of a relatively hard metal enables the offset member 132 and the mounting feature 140 to withstand shocks encountered during appliance transit better.

To assemble the electrical motor 100, the flanges 136 of the mounting feature plate 108 are interposed between a lower surface of the end shield 104 at the mounting hole 124 and an upper surface of the stator 112. A mounting bolt can then be inserted into the mounting hole 124, through a hole in the flange 136 and passed through a mounting hole in the stator 112 so the bolt can be rotated in a threaded opening in the other end shield to secure the end shield 104 and the mounting feature plate 108 to the stator 112.

One issue that can arise with the structure described in the previous paragraph is the interface between the smooth lower surface of the plastic end shield 104 and the smooth upper surface of the mounting feature plate flange 136. Some forces arising from shocks that the appliance receives during transit may move the end shield 104 with respect to the stator 112 as the steel mounting feature plate 108 tends to slide with respect to the plastic surface of the end shield. When the plate 108 slides, it can engage the bolt passing through the hole in the flange and skew the stator with reference to the rotor. This skewing can affect the air gap between the stator and the rotor and the efficiency of the electrical motor.

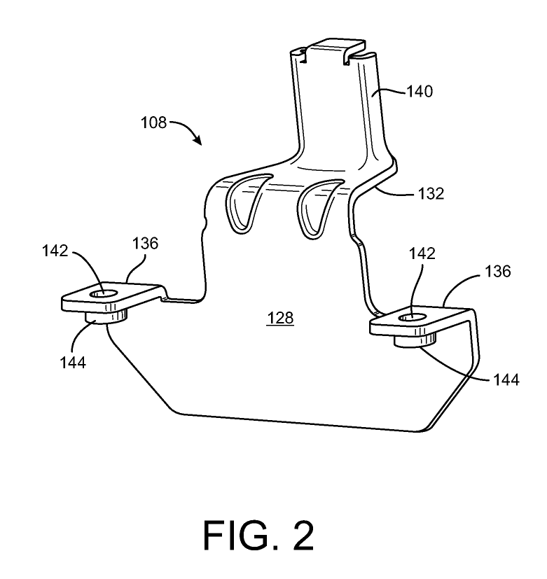

To address the possible sliding of the steel mounting feature plate, the flanges 136 have been formed to include extrusions at the holes in the flanges. Such a mounting feature plate 108 is shown in FIG. 2. The mounting feature plate 108 again includes a planar member 128, an offset member 132, a mounting feature 140, and the flanges 136. Each flange includes an opening 142 and an extrusion 144. The extrusion 144 is a generally cylindrical wall having an opening that is aligned with the opening 142.

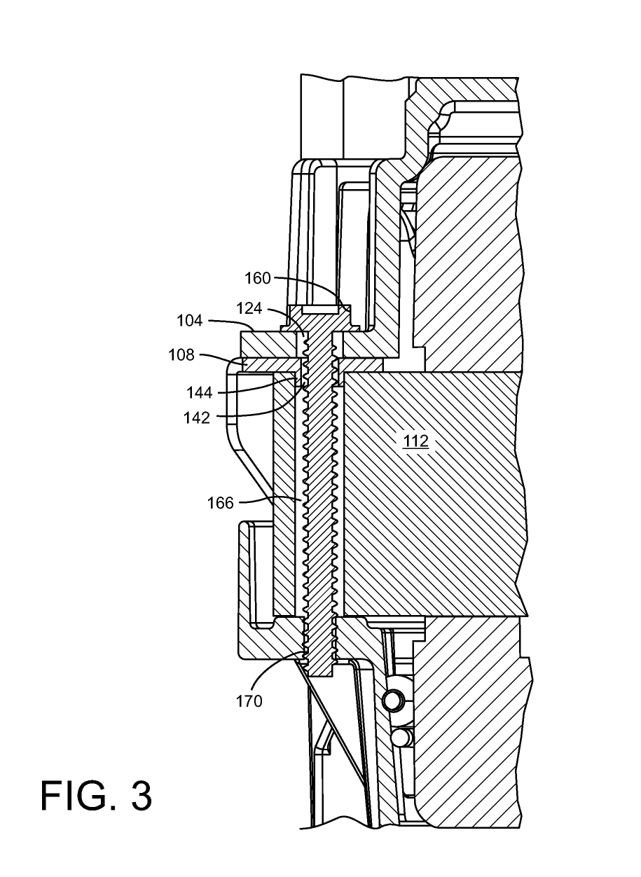

The extrusion 144 is configured to fit within the clearance between a mounting bolt and mounting hole in the stator and the end shield. A cross-sectional view of a portion of an electrical motor having the mounting feature plate with a mounting hole extrusion is shown in FIG. 3. Using like reference numbers for like structures, the hole 124 in the end shield 104 is aligned with hole 142 in the mounting feature plate 108 and hole 166 in the stator 112. The extrusion 144 fits within the clearance between bolt 160 and the wall of hole 166 in the stator 112. The bolt 160 passes through the aligned holes to enable an end of the bolt to be rotated in the threaded opening 170 in the other end shield 174 to secure the end shield 104, the mounting feature plate 108, and the end shield 174 to the stator 112.

The extrusion 144 should be long enough that it attenuates movement of the mounting feature plate 108 and end shield 104 relative to the stator 112. In one embodiment, the extrusion is at least as long as a thickness of two laminations that form the stator 112 to secure the plate adequately to the stator, although the extrusion can have a length that is the thickness of one lamination or even less provided that the length of the extrusion is sufficient to keep the end shield 104 and plate 108 from moving relative to the stator 112. In this embodiment, each lamination is 0.31″ thick so the extrusion is 0.62″ in length. The length of the extrusion also needs to be sufficiently long to ensure that the extrusion is formed with a diameter during manufacture that satisfies the tolerance for the extrusion fitting within the mounting holes. The clearance between the stator mounting hole and the outer wall of the extrusion 144, and between the bolt and the inner wall of the extrusion 144 is such that the mounting feature plate is relatively rigidly mounted to the stator. Thus, a proper fit of the extrusion within a mounting hole is important so the extrusion needs to be long enough to ensure that during manufacture of the plate 108 the extrusion diameter is formed within the tolerance needed for fitting the extrusion into a mounting hole and enabling a mounting bolt to pass through the extrusion. The fixing of the plate 108 to the stator 112 helps prevent the mounting feature plate 108 from slipping with respect to the end shield 104 to maintain the integrity of the air gap between the stator and the rotor despite shocks encountered during appliance shipping.

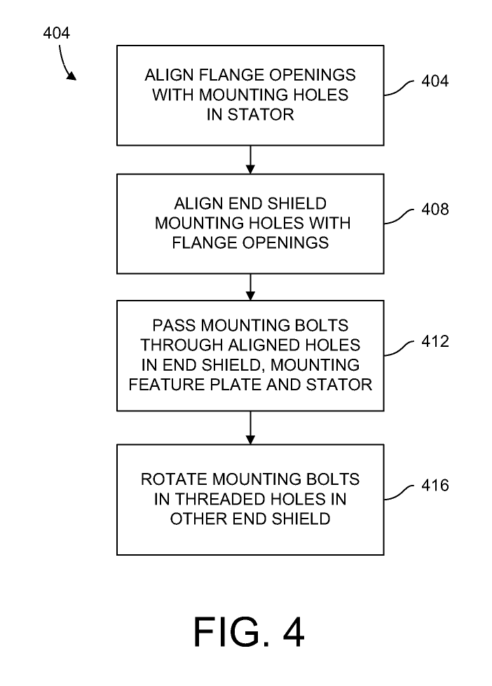

A flow diagram of a process for assembling an electrical motor with a hard metal mounting feature plate is shown in FIG. 4. The process 400 includes aligning openings in the flanges of a hard metal mounting feature plate with mounting holes in a stator to enable extrusions extending from the mounting feature plate to be received by the stator mounting holes (block 404). Mounting holes in the mounting slots of an end shield are then aligned with the mounting holes in the flanges of the mounting feature plate (block 408). A bolt is inserted into each of the mounting holes in the end shield and then passed through the aligned holes in the mounting feature plate and the stator (block 412) so the end of the bolt is received in the threaded hole in the other end shield. The bolt is then rotated to advance the bolt into the threaded hole in the other end shield to secure the end shield and the mounting feature plate to the stator (block 416). The electrical motor can then be mounted in the appliance and shipped with less risk that the electrical motor can be dislodged from its installed position in the appliance.

Those skilled in the art will recognize that numerous modifications can be made to the specific implementations described above. Therefore, the following claims are not to be limited to the specific embodiments illustrated and described above. The claims, as originally presented and as they may be amended, encompass variations, alternatives, modifications, improvements, equivalents, and substantial equivalents of the embodiments and teachings disclosed herein, including those that are presently unforeseen or unappreciated, and that, for example, may arise from applicants/patentees and others.

1. A mounting feature plate for an electrical motor comprising:
a planar member;
an offset member extending from the planar member, a terminating portion of the offset member being configured to engage a portion of a frame in an appliance for mounting an electrical motor within an appliance; and
at least one flange extending from the planar member in a direction that is generally orthogonal to the planar member, the flange having an opening with a cylindrical extrusion aligned with and extending from the opening, the extrusion being configured to be received within a mounting hole within a stator and the opening being configured to enable a bolt to pass through the opening and the extrusion to be received within the mounting hole in the stator.

2. The mounting feature plate of claim 1 wherein the at least one flange includes a pair of flanges extending from the planar member in a direction that is generally orthogonal to the planar member, each of the flanges in the pair of flanges having an opening with a cylindrical extrusion aligned with and extending from the opening, the extrusion of each flange being configured to be received within a mounting hole within a stator and the opening in each flange being configured to enable a bolt to pass through the opening and the extrusion in each flange to be received within the mounting hole in the stator.

3. The mounting feature plate of claim 2 wherein the planar member, the offset member, and the pair of flanges consist essentially of steel.

4. The mounting feature plate of claim 2 wherein the extrusion extending from each opening in the pair of flanges extends at least a thickness of at least two laminations forming the stator.

5. An electrical motor comprising:
an output shaft;
a rotor mounted about the output shaft;
an end shield with an opening through which the output shaft extends;
a stator secured to the end shield; and
a mounting feature plate interposed between the end shield and the stator, the mounting feature plate comprising:
a planar member;
an offset member extending from the planar member, a terminating portion of the offset member being configured to engage a portion of a frame in an appliance for mounting the electrical motor within an appliance; and
at least one flange extending from the planar member in a direction that is generally orthogonal to the planar member, the flange being interposed between a surface of the end shield and a surface of the stator, each flange having an opening with a cylindrical extrusion aligned with and extending from the opening, the extrusion being configured to be received within a mounting hole within the stator and the opening being configured to enable a bolt to pass through the opening and the extrusion to be received within the mounting hole in the stator.

6. The electrical motor of claim 5 wherein the at least one flange includes a pair of flanges extending from the planar member in a direction that is generally orthogonal to the planar member, each of the flanges in the pair of flanges having an opening with a cylindrical extrusion aligned with and extending from the opening, the extrusion of each flange being configured to be received within a mounting hole within a stator and the opening in each flange being configured to enable a bolt to pass through the opening and the extrusion in each flange to be received within the mounting hole in the stator.

7. The electrical motor of claim 6 wherein the planar member, the offset member, and the pair of flanges consist essentially of steel.

8. The electrical motor of claim 6 wherein the end shield consists essentially of plastic material.

9. The electrical motor of claim 6, each mounting hole in the stator further comprising:
a clearance between a bolt within each mounting hole and an outside wall of each mounting hole to receive the extrusion extending from one of the flanges of the mounting feature plate.

10. The electrical motor of claim 6 wherein the extrusion extending from each opening in the pair of flanges extends a distance that corresponds to a thickness of at least two laminations comprising the stator.

11. A method of assembling an electrical motor comprising:
aligning openings in flanges of a hard metal mounting feature plate with threaded mounting holes in a stator to enable extrusions extending from the hard metal mounting feature plate to be received by the stator mounting holes;
aligning mounting holes in an end shield with the openings in the flanges of the mounting feature plate;
inserting a bolt into each of the mounting holes in the end shield and through the aligned opening in the mounting feature plate to position an end of each bolt in one of the threaded holes in the stator; and
rotating each bolt to advance each bolt into one of the threaded holes in the stator to secure the end shield and the mounting feature plate to the stator.
